(19) United States
(12) Patent Application Publication
(10) Pub. No.: US 2026/0277390 A1
(43) Pub. Date: Sep. 17, 2026

(54) COMPUTER IMPLEMENTED METHOD AND SYSTEM FOR LAUNCHING CONTENT

(71) Applicant: David DUKE, Corby (GB)

(72) Inventor: David DUKE, Corby (GB)

(21) Appl. No.: 19/080,100

(22) Filed: Mar. 14, 2025

(51) Int. Cl. G06F 3/04817; G06F 3/04815; G06F 3/0482; G06F 3/04842; G06F 3/0485

(52) U.S. Cl. CPC G06F 3/04817; G06F 3/04815; G06F 3/0482; G06F 3/04842; G06F 3/0485; G06F 2203/04806

(57) ABSTRACT

A computer implemented method comprising: displaying a portion of a virtual space; responsive to a panning input, panning the displayed portion of the virtual space to a part of the virtual space containing one or more interactive symbols, each of the one or more interactive symbols being associated with content; responsive to a selection input: selecting one of the one or more interactive symbols; and launching the content associated with the selected interactive symbol. A system comprising a display device, an input device, and a processor is also described.

### TECHNICAL FIELD

The present disclosure relates to methods and systems for launching content, in particular using symbols within a virtual space (e.g. as part of a desktop environment, such as for a computer operating system).

### BACKGROUND

Existing desktop computer environments employ a limited hierarchical location process, which can require a lot of time and resources to locate and navigate to information required by a user.

Traditional systems also generally have a fixed action process based on a file's data type, which may limit functionality globally.

Furthermore, known systems are limited by a fixed window or windows with fixed size icons, meaning that more data results in reduced fidelity for identification and limits the availability and visual representation of information.

### SUMMARY

The present disclosure therefore provides an improved way to locate and retrieve content (such as information or data stored locally and/or remotely, and/or running computer code or launching a computer program) using a computer. According to the present disclosure, content may be located by panning and/or zooming a virtual space to display an interactive symbol associated with content, and locating the content associated with the interactive symbol (e.g. following selection of the interactive symbol). The present disclosure may therefore provide a “course-to-fine” mode of content retrieval by a desktop computer environment, which may enable faster retrieval of content by the user compared with known systems.

The present disclosure also provides an interactive object (which may be, or be represented by, a symbol). The interactive object may be selectable. The interactive object may represent, or link to, content, including computer programs, files, and/or computer code, which may be stored locally or remotely, e.g. on a server (such as in the cloud). In some examples, the content may be retrieved from the web.

In some examples, the action to be taken upon selection of the interactive object (or symbol) may be dynamically derived. For example, the action may comprise launching a computer program, opening a file, executing computer code, playing media, causing the symbol to change (e.g. in size, shape, color, or to be replaced by a different symbol), etc. The action may be dynamically derived based on the locality of the interactive object. For example, the interactive object may be context aware, and/or intelligent. The action may be dynamically derived based e.g. on a location of the interactive object within the virtual space, based on other interactive objects in the vicinity of the interactive object, and/or based on current and/or historical interactions with the interactive object (e.g. selection and/or non-selection interactions).

The symbol may be customizable (e.g. the interactive symbol may have any shape, size, color, or other property desired by the user). In some examples, the interactive object may cause an animation, sound, movie or other media to be played when selected and/or when a user otherwise interacts with the interactive object (e.g. by hovering a pointer or cursor over the interactive object). In some examples, the properties (e.g. the shape and/or color, and/or associated animations or audio) of the symbol may depend on the content associated with the interactive object.

In addition, the present disclosure provides a repository for the storage of content. Content stored in the repository may be assigned a unique content identifier inside one file (e.g. the repository may have a dynamic and/or relational structure). The file may be encrypted. The repository may therefore provide more streamlined and centralized management of content compared with traditional directory-based file management systems.

Described herein is a computer implemented method. The computer implemented method may be for locating and/or retrieving content. The computer implemented method comprises displaying (e.g. on a display device such as a screen, a monitor, or a virtual reality or augmented reality display) a portion of a virtual space. The displayed portion of the virtual space may contain one or more interactive symbols. The computer implemented method may comprise, responsive to a panning input, panning the displayed portion of the virtual space to a part of the virtual space containing one or more interactive symbols. Each of the one or more interactive symbols may be associated with content. It will be understood that the displayed portion of the virtual space prior to the panning input may be empty of interactive symbols, in some examples. The computer implemented method may comprise, responsive to a zooming input, increasing (i.e. zooming out) or decreasing (i.e. zooming in) an amount of the virtual space displayed in the displayed portion of the virtual space. The computer implemented method may comprise, responsive to a selection input: selecting one of the one or more interactive symbols; locating the content associated with the selective interactive symbol; and/or launching the content associated with the interactive symbol.

The computer implemented methods according to the present disclosure may therefore provide a more efficient way of locating content in a computer system, where information is structured to leverage a user's spatial awareness.

In some examples, decreasing an amount of the virtual space displayed in the displayed portion comprises increasing an amount of detail of one or more interactive symbols displayed in the displayed portion. For example, zooming into the virtual environment may result in features of the symbol becoming visible on the display that are not visible (and may not be displayed) when the displayed portion is zoomed out. Such features may include image details, text, and/or other visuals. In some examples, decreasing an amount of the virtual space displayed in the displayed portion causes symbols to appear that are not displayed in wider zoom views. For example, some (e.g. smaller) symbols may be arranged around a larger symbol. The smaller symbols may be associated with content that is related to the content associated with the larger symbols (for example the smaller symbols could relate to files that are part of a same project as the larger symbol). The smaller symbols may not be visible at certain zoom scales, until the user has sufficiently zoomed in on the region or portion of the virtual space containing the larger symbol. Therefore, in some examples, the computer implemented method may comprise, in response to a zooming input, changing a quantity of interactive symbols displayed in the displayed portion of the virtual space.

In a particular example according to the present disclosure, a computer implemented method (e.g. for launching content) may comprise: responsive to a selection input, selecting an interactive object within a virtual space, the interactive object being represented by a symbol; responsive to the selection, dynamically deriving content to be launched; and launching the content.

It will be understood that “content” according to the examples described herein may comprise a file, a computer program, a media or multimedia file, text, an image. Content may be stored locally, remotely, on the internet, within a repository as described herein, on a removable storage medium, or elsewhere. In some examples, content may be dynamically, or automatically, derived or generated upon selection of the interactive object symbol. For example, the content may be computed (e.g. by execution of a program, or an artificial intelligence (AI) prompt) responsive to selection of the object or symbol. In some cases, the content could be derived from multiple sources. Launching content may comprise opening a file, running a computer program, generating or deriving the content (e.g. dynamically/automatically as described herein), etc. It will be appreciated that launching, or deriving, content may include locating the content.

In some examples, a visual property of one or more of the interactive objects or symbols is at least partially determined by the content associated with the interactive object or symbol. For example, the symbol associated with a document that relates to cars could be displayed as an image of a car.

In some examples, responsive to a non-selection interaction with an object or symbol, an identifying action associated with the symbol may be automatically performed. A non-selection interaction may comprise, for example, hovering a pointer or cursor (e.g. a mouse pointer) over the symbol or close to an object or symbol (e.g. within a predefined radial distance from the object or symbol), highlighting the object or symbol (e.g. using arrow keys on a computer keyboard), gesturing (e.g. using a pointer or cursor) over or around the object or symbol, and/or changing the locality of the object or symbol by rearranging or interacting with other objects or symbols in the vicinity.

The identifying action may be dynamically defined or derived, similarly to the content, in some examples. In some examples, the identifying action may be programmatically defined (e.g. defined by the user as part of a customization of the symbol or object).

Examples of identifying actions include animating the symbol, and/or playing media such as audio and/or video.

In some examples, a relative size of at least one symbol may be (e.g. automatically) changed according to a relative number of times that the content associated with the at least one symbol (or the object represented by the symbol) is accessed (e.g. launched). For example, larger symbols may correspond to content that has been accessed more often, or that is accessed more frequently, than content associated with smaller symbols. The user may therefore be able to locate the content that is most important to them quickly since its symbol(s) will be more prominent within the virtual space. It will be understood that the user may also be able to edit the size(s) of symbols manually according to preference, and/or importance, as part of the general customization of the symbols and the virtual space.

In some examples, the virtual space may include a toolbar. At least some of the symbols (or objects) may be accessible from (i.e. displayed in) the tool bar, e.g. in addition to the pannable/zoomable virtual space. The toolbar may be infinitely scrollable, such that there is no limit to the number of objects or symbols that can be included in the toolbar.

In some examples, content may be stored in a repository. The repository may have a dynamic or relational storage structure. For example, the content may be assigned a unique content identifier within the repository. In some examples, the repository may be compressed. In some examples, the repository may be encrypted, for example the repository (or the content in the repository) may be assessable using a cryptographically secure key.

As described herein, content to be launched by selection of an object or symbol may be dynamically derived (e.g. the content to be launched may be determined at the point of selection of the object or symbol).

In some examples, the content may be dynamically derived based on a locality of the symbol or object within the virtual space (e.g. based on a location of the object or symbol within the virtual space, based on current or historic interactions, and/or based on other symbols or objects in the vicinity).

It will be understood that dynamically deriving the content may include determining that the object or symbol is linked to content such as a file or program in a fixed manner, and (therefore) opening the file or program every time that object or symbol is selected.

In some examples, the content comprises executable computer program code. Launching the content may therefore comprise executing the computer code. In some examples, the content comprises a prompt, such as for a machine learning model, e.g. a large language model (LLM). Launching the content may comprise inputting the prompt into a machine learning model (e.g. automatically inputting the prompt).

In some examples, launching the content may comprise performing a calculation or computation, thereby generating the content as an output or result of the calculation or computation.

It will be understood that the virtual space described herein may be e.g. two-dimensional (2D) or three-dimensional (3D).

In some examples, the virtual space is infinite in all dimensions.

In an example described herein, there is provided a system comprising a display device (e.g. a screen, a monitor, or a virtual or augmented reality display such as a headset), an input device (where the input device may comprise one or more of a mouse, keyboard, tablet, touchscreen, motion tracking device, joystick, motion control device, etc.) and a processor. The processor may be configured to perform one or more of the methods described herein. For example, the processor may be configured to: cause the display device to display a portion of a virtual space; responsive to a panning input from the input device, cause the portion of the virtual space displayed on the display device to pan to a part of the virtual space containing one or more interactive symbols, each of the one or more interactive symbols being associated with content. The processor may be configured, responsive to a selection input from the input device, to: select one or more of the interactive symbols; and launch the content associated with the selected interactive symbol. In some examples, the system may comprise a non-transitory computer readable storage medium, and the content may be stored in, and/or derived from data or information stored in, the non-transitory computer readable storage medium.

It will be understood that, in at least some examples, references to an interactive symbol may equivalently refer to an interactive object (where the interactive object may be represented by a symbol as described herein).

In another example described herein, there is provided system comprising: a processor; and a non-transitory computer readable medium, the non-transitory computer readable medium having a repository stored thereon, the repository having a dynamic and/or relational file storage structure. The processor is configured to: receive content to be stored in the repository; assign, to the content, a unique content identifier to enable location and/or retrieval of the content; and transfer the content, with the assigned unique content identifier, to the repository.

For example, a user could drag and drop a symbol, object, or icon representing a file stored in a storage medium into a desktop environment (e.g. virtual space), and the processor may then transfer (or copy) the file to the repository.

In some examples, a particular repository is represented by, or accessible via, a dedicated virtual space.

In some examples, a virtual space may be accessed via a symbol in another virtual space (e.g. a second virtual space may appear to be embedded in a first virtual space).

The repository may be encrypted according to an encryption scheme.

As an example, wherein an encryption scheme may comprise combining a first unique user identifier associated with a first user and a second unique user identifier associated with a second user to create a cryptographically secure key, and encrypting the repository using the cryptographically secure key.

An example of a unique user identifier is an email address.

For example, a repository may be accessible by two or more users (identified by their email addresses) via symbols in their respective personal virtual spaces. The jointly accessed repository may be represented by another virtual space (which may comprise one or more symbols), which may update in real time in response to inputs by the users to enable collaborative working.

### BRIEF DESCRIPTION OF THE DRAWINGS

Some embodiments of the disclosure will now be described by way of example only and with reference to the accompanying figures, in which:

FIG. 1 schematically illustrates an example of a system according to the present disclosure;

FIGS. 2A and 2B illustrate examples of a pannable virtual space according to the present disclosure;

FIGS. 2C and 2D illustrate examples of a zoomable virtual space according to the present disclosure;

FIG. 3 illustrates an example of a virtual space comprising a toolbar according to the present disclosure;

FIG. 4 illustrates examples of a workflow, and position-aware features of a virtual space, according to the present disclosure;

FIG. 5 illustrates an example of a method according to the present disclosure; and

FIG. 6 illustrates another example of a method according to the present disclosure.

### DETAILED DESCRIPTION

The present disclosure provides systems and methods for launching content using a computer. For example, the present disclosure may provide a desktop computer environment (e.g. for a computer operating system) that may improve user experience and/or productivity compared with known environments.

As described herein, current desktop environments generally use a limited hierarchical location process, which takes time and resources to find and navigate to the information required. Traditional systems generally have a fixed action process based on the files data type. Limiting functionality globally. Traditional systems are also limited by a fixed window or windows with fixed size icons, more data results in reduced fidelity for identification and limiting the availability and visual representation of information.

The present disclosure provides a visual coarse-to-fine retrieval strategy, rather than a hierarchically based one which is used by traditional interfaces. This means that information is spatially located using a rough recall of where information is then using the scalable interface to rapidly location the action location of information. The desktop environment described herein (which may be arranged in a virtual space as described herein) is a project orientated environment, where projects define how data is organized. Information may be organized spatially within a virtual space or environment. The virtual space or environment may function as a structured memory system, leveraging spatial awareness and visualization to enhance recall.

Unlike a traditional hierarchically based interfaces, the invention according to the present disclosure utilizes a mental approximation of where information is generally stored, then using scaling techniques reveals additional details resulting in rapid pinpointing of the information's precise location. This method facilitates swift and accurate identification, significantly reducing the time and resources typically needed for information retrieval. In contrast, traditional operating systems rely on inefficient hierarchical interfaces to locate information.

In some examples, the systems and methods described herein may not by default affect the location of underlying files and folders in an operating system, with the exception in some cases of files or other content that is native to the desktop environment described herein. Filenames and locations may therefore not be important to the retrieval and/or launching of content as described herein, as information may be represented visually and abstracted away from physical names or locations.

The invention described herein may provide a symbol and shape visual based operating system or desktop environment. Customizable and dynamic symbols are a more efficient and easier method to identify information over fixed icon images and text. Text is not required (e.g. as part of a symbol) but may be optional. Additionally, icons are not required and text can be used on its own to represent information (i.e. a symbol or object described herein may comprise or consist of text without an image or other icon).

The present disclosure may provide an intelligent visual driven object-based interface.

The present disclosure may provide a fully customizable desktop workspace where objects behave based on topology, location or content, allowing for intuitive spatial interactions. With an integrated programming language embedded in the symbols themselves, users can define behaviors, automate workflows and create interactive environments. The systems and methods can support dynamic repositioning, context-sensitive, spatially based actions and programmable rules that execute user-defined logic. This enables a fluid and intelligent workspace tailored to individual demands.

The present disclosure may provide a desktop environment using the concept of a mind palace. A mind palace, also known as the method of loci, is a construct where information is organized spatially within an imagined or virtual environment. It functions as a structured memory system, leveraging spatial awareness and visualization, mapping the natural progression of thoughts leading to familiarization to significantly enhance recall. The systems and methods described herein realize this concept to enable users to locate information rapidly. The virtual space described herein may be provide an unlimited size scrollable and scalable interface, which uses intelligent symbols and not traditionally fixed image icons based on applications associations as used by current desktop user interfaces.

The interface described herein may be compatible with existing operating systems (including Windows®, Mac®, and/or Linux® based operating systems, as well as mobile operating systems). However, the interface may be independent of the underlying operating system such that a user experiences the same desktop environment for any underlying operating system. This means that a user only needs to learn one user interface, regardless of the device or operating system used, making computer interaction simpler and more intuitive.

By integrating these principles into a desktop interface, the present invention may provide a visually rich, intuitive, and responsive environment that feels more like an evolving digital landscape than a static desktop.

In some examples, the interface has an unlimited sized work area which is draggable/pannable and visually scalable resulting in increased visual fidelity, enabling a user to rapidly access information by quickly scaling the interface to leverage its enhanced topology, thus increase recall of the visually accessible information.

The icons in existing operating system user interfaces may indicate the application used to open the associated file, and not the data contents, preventing the accurate identification of information. In contrast, according to the present disclosure, symbols and attributes like size and shape can accurately represent the content of the information to enable rapid and accurate identification. Visual recognition is significantly faster than textual identification, increasing productivity and ease of use.

In at least some cases described herein, a “workspace” may refer to a desktop environment or virtual space that may be of unlimited size.

It will be understood that content as described herein may be represented by a unique symbol regardless of data type or application associated or location.

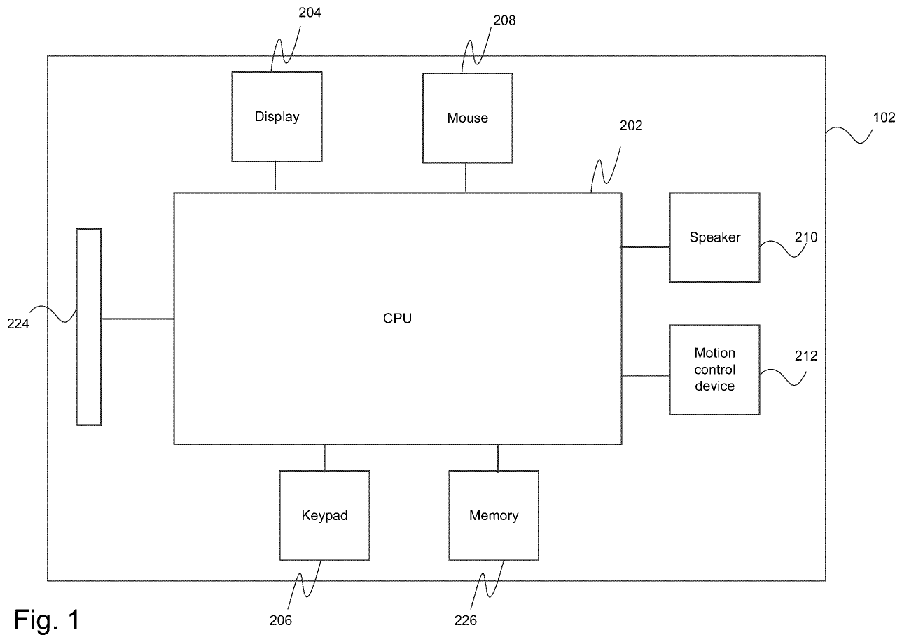

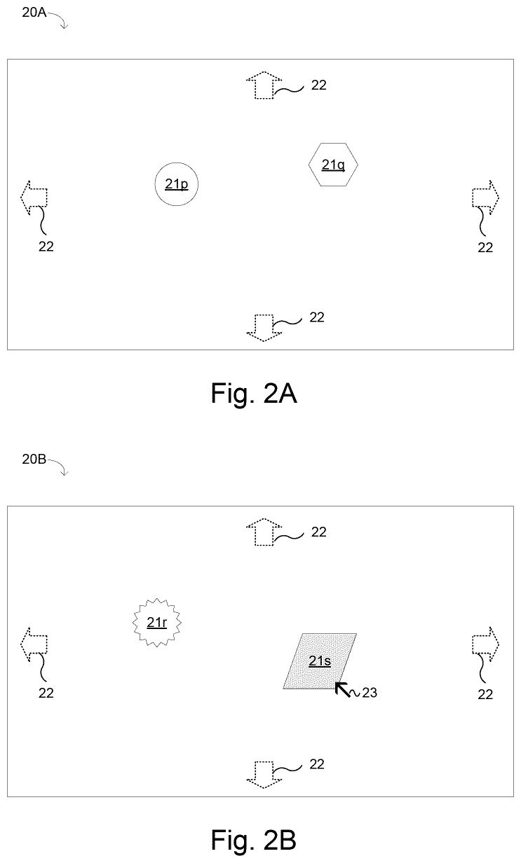

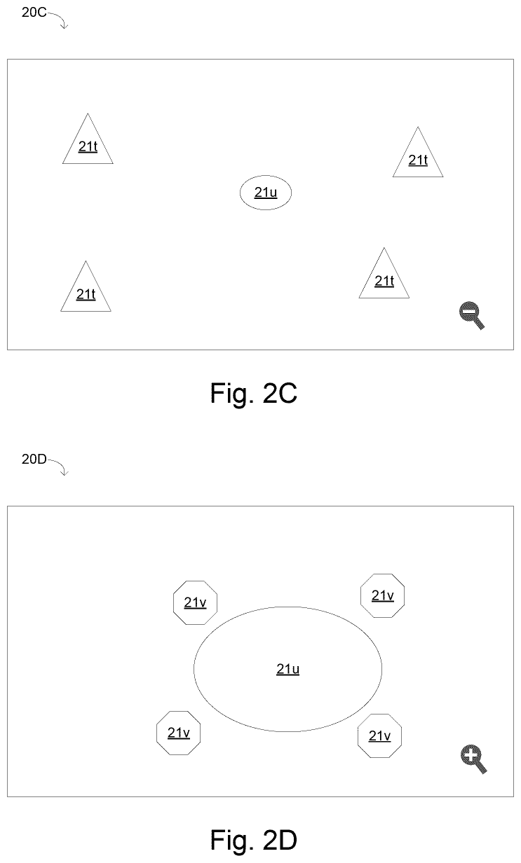

FIG. 1 schematically illustrates an example of a system according to the present disclosure (which may be, or may comprise, a computer) 102 on which methods according to the present disclosure may be implemented. The system 102 comprises a processor, which may be a central processing unit (“CPU”) 202, to which is connected a display 204 such as a screen or touch screen, input devices such as a keypad 206 (also referred to as a keyboard), a mouse 208, motion control device 212 (which may comprise a camera and/or sensor), and touch screen 204. An audio output device 210 (e.g. a speaker) is connected to the CPU 202. The display 204, keypad 206, mouse 208, audio output device 210, and motion control device 212 may be integrated into the system 102 to form a user terminal in some examples. In alternative examples one or more of the display 204, the keypad 206, the mouse 208, the audio output device 210, and the motion control device 212 may not be integrated into the system 102 and may be connected to the CPU 202 via respective interfaces. One example of such an interface is a USB interface. The CPU 202 is connected to a network interface 224 such as a modem for communication with the network 106. The network interface 224 may be integrated into the system 102 as shown in FIG. 2. In alternative examples the network interface 224 is not integrated into the system 102. The system 102 also comprises a memory 226 for storing data as is known in the art. The memory 226 may be a permanent memory, such as ROM. The memory 226 may alternatively be a temporary memory, such as RAM.

Methods according to the present disclosure may be carried out, for example, by the system 102, and/or by a network entity on a network (e.g. where the system 102 is connected to the network via the network interface 224).

Alternatively, or in addition, methods according to the present disclosure may be carried out, for example, by software stored on, or accessible to (e.g. cloud-based software) the CPU 202 via the network, and the system 102 may comprise storage devices that are accessible via the network (e.g. cloud-based storage).

FIGS. 2A-2D illustrate examples of a displayed portion of a virtual space according to the present disclosure. As described herein, the virtual space may be a pannable and/or zoomable virtual environment.

In FIG. 2A, a portion 20A of a virtual space is displayed, for example on the display 204 illustrated in FIG. 1. In some examples, the portion 20A of the virtual space may be displayed on a screen, monitor, and/or virtual reality (VR) or augmented reality (AR) display (e.g. a VR or AR headset). The displayed portion 20A of the virtual space represents only part of the whole virtual space, which may be explored by a user e.g. by panning and/or zooming as described herein. As described herein, the virtual space may be 2D or 3D, and may be infinite in some examples.

The displayed portion 20A of the virtual space may include one or more interactive symbols 21p, 21q. The displayed interactive symbols 21p, 21q may represent a fraction of the total number of interactive symbols contained in the virtual space. To navigate to a different portion of the virtual space, a user may pan (e.g. left/right/up/down, as represented by the dotted arrows 22) using a panning input. The panning input may be provided using, e.g., a mouse and/or keyboard command combination (e.g. click, scroll, drag, arrow key press, key combination, etc.), a swipe on a touchscreen, and/or a motion control system for a VR or AR system.

Following the panning, a different portion 20B of the virtual space is displayed, as illustrated in FIG. 2B. The different portion 20B of the virtual space may contain interactive symbols 21r, 21s that are different from the interactive symbols displayed in the portion 20A. It will be understood that it is possible to pan to an intermediate position within the virtual space, between the portions 20A and 20B, which may overlap with both the portions 20A and 20B in some cases (e.g. such that one or more interactive symbols 21p, 21q, 21r, 21s from each of the portions 20A and 20B are displayed).

A user may provide a selection input, e.g. by aiming a mouse pointer 23 at a particular symbol 21s and e.g. clicking the mouse. Selecting the symbol 21s may cause content associated with the selected symbol to launch.

In some examples, a zooming input (e.g. using a mouse or keyboard command, including clicking and/or scrolling, or by a pinch interaction with a touch screen) may be provided. FIG. 2C illustrates a portion of a virtual space in which interactive symbols 21u, 21t are displayed. By zooming in on a particular interactive symbol 21u, other interactive symbols 21t may exit the field of view and the interactive symbol 21u that is the focus of the zoom may be enlarged within the displayed portion 20D, as shown in FIG. 2D. In some examples, additional details such as text or images that form part of the symbol 21u may become visible as a result of the zooming in. In some examples, additional symbols 21v (for example that are too small to be displayed when zoomed out) in the vicinity of the symbol 21u may become visible following the zooming in. Therefore, in some examples, the zooming may provide the effect of a 3D environment. The appearance and/or disappearance of symbols 21t, 21v due to zooming may, in some examples, correspond to the technique in computer graphics of culling objects that are not within the user's field of view.

Advantageously, the draggable/pannable/zoomable interface described herein increases available workspace seamlessly, without using traditional desktop swapping. In addition, zooming into symbols enables individuals with visual impairments to access information more easily. The use of high-resolution images as symbols may ensure that enlarging a symbol reveals more detailed text and visuals. In some examples, symbols can be resized without limits, so that they can be recognized at any scale.

The ability to pan around a desktop and scale in and out, gives a unique perspective in data access. It significantly reduces the time to find information, and gives the user infinite space to organize information. Visual, clear detailed information about a specific piece of information may be displayed at one level. Scaling out then provides more visual context to discover related information instantly, without the need to drill down into hierarchical folder structures to find and access information.

As described herein, a symbol may represent an interactive object, or may itself be an interactive object.

The interactive symbols (or interactive objects) described herein are associated with content, for example applications, resources, data, functions, files, etc. References to features of symbols, or interactive symbols, described herein may also apply to interactive objects as described herein.

In some cases, the action that is performed upon selection or interaction with a particular symbol may be determined dynamically, or derived, at the point of selection or interaction with the symbol. For example, the processor of the computer may determine what action to perform (where the action may comprise opening a file but could comprise something else such as the performing of a calculation).

For example, a symbol could be associated with, or could contain, a list of instructions (e.g. a computer program), an embedded application, a machine learning prompt, or an interface with an external source (such as the internet).

In an example, symbol may contain a complete interactive user interface contained with the symbol structure itself which can be manually or automatically triggered. These actions can interact with other symbols to trigger actions in a cascading style. This means that each symbol in the workspace can be a unique function or action regardless of the data it contains. Making it easier to identify information and to automate processes to increase productivity.

In known desktop environments, all application icons (for example Microsoft® Word documents) have a same icon regardless of content, making content identification impossible without the need to read and understand a filename which significantly slows down the user access process.

For example, a user may have access to 40 documents in a list. To find a document about butterflies, they would need to read every filename to identity the document about butterflies, because every document would have the same icon (e.g. Microsoft® Word icon). In contrast, according to the present disclosure, a symbol representing the document about butterflies may (e.g. automatically) take the form of an image of a butterfly meaning that the user can recognize the document almost instantly, therefore increasing accessibility, productivity and efficiency of a desktop environment.

The efficiency gains due to the invention described herein may also reduce time spent, and electricity consumption.

In other examples, symbols for documents about could comprise a flower (the symbol may create a flower icon if required), and a document about a car could have a car symbol, making visual recognition of content much quicker regardless of the application associated with the data.

In some examples, a symbol may be associated with information that is accessed via the internet (e.g. a webpage). For example, each webpage/app/data file or external link may have its own visual representation in the symbol(s). File names may not be required to identify the data regardless of where the data is or what application is required to access it. “Data” or “content” could be local apps, local data, remote sites, files, images, media, or anything else. The symbol represents the information content itself, not where the data is or what application is associated with the data. In some examples, the content could be an application executed from within the symbol (or object) itself.

In some examples, symbols according to the present disclosure can overlap. Symbols (or objects) can be intelligent and interactive as they can contain instructions/tasks or detailed code/applications. Actions/code tasks can be run by automatically by gestures or passing over a symbol without interacting with it. This can make symbols/objects environment and context aware.

Scaling, zooming, and/or and panning gives a greater fidelity of imagery to increase rapid recognition of large amounts of visual information. This also makes text easier to read which again speeds up information identification.

In some examples, the infinite desktop concept extends to the expanding the traditional fixed toolbar icons, into a limitless multi layered toolbar work area. Using the same concept of infinite scrolling to access more items than could normally be presented on a fixed toolbar.

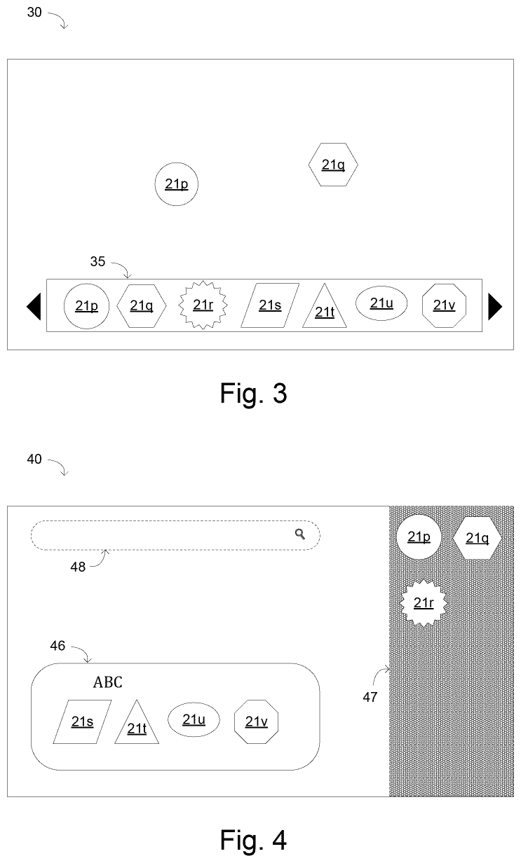

FIG. 3 illustrates an example of a displayed portion 30 of a virtual space in which a toolbar 35 is displayed. In some cases, the toolbar 35 may be fixed on the display (e.g. screen) while the displayed portion 30 is panned and/or zoomed, such that the presence and position of the toolbar 35 is independent of the part of the displayed portion. It may be possible to toggle the toolbar 35 to show/hide the toolbar 35 as desired, so that the toolbar 35 is not necessarily visible at all times.

The toolbar 35 may show some, or all, of the symbols 21p-v that are contained in the virtual space (i.e. not just those symbols 21p, 21q that are visible in the displayed portion 30 of the virtual space).

The toolbar 35 may be scrollable, so that only a portion of the total number of symbols displayable by the toolbar are visible at a given time. In some examples, the toolbar may be infinitely scrollable.

In some examples, the symbols 21p-v displayed in the toolbar may move in the opposite direction to a mouse pointer. In some examples, the symbols have an unlimited width. In some examples, the symbols can dynamically move and scroll from offscreen to match the width of the display. Advantageously, a long list of symbols 21p-v may be displayed while still using the width of a single screen and mouse movement.

In some examples, the toolbar 35 may be able to display symbols that are otherwise not visible in the virtual space.

Symbols according to the present disclosure may not be of fixed sizes, and may even not be limited to static images. For example, symbols could be animated or even comprise video), and therefore hold more reference information to help identify information visually.

Symbols and workspaces may have their own dynamic abilities to automate tasks or run functional code. For example, a workspace, may play music when entered to give more information about to symbols contained therein. Panning the screen or moving the mouse over an item or to a specific area of the screen can trigger actions.

Symbols can also animate or contain other visible markers internally to the image (icons pictures labels etc.) to show more reference information.

Additionally adding shapes to symbols can represent more information even data types, in contrast to traditional operating system interfaces where icons use fixed images to represent the ownership of files. In some examples, the size and/or shape of a symbol may represent importance and/or data types. For example, the size and/or shape of a symbol may automatically change according to the number of times the content associated with that symbol is launched (e.g. where a larger symbol may be associated with more frequently launched, or accessed, content). With the addition of the layout of groups of symbols, even more information about a piece of information can be provided.

In an example, a group of symbols may represent a group of playable movies. A specific symbol shape may indicate the movie type (e.g. genre) visually. Alternatively, or additionally, symbol size could be used to represent the movie's popularity (e.g. according to the number of times the movie is played by one or more users).

In another example, a group of pictures may be represented by symbols having a picture shape to indicate their type visually.

In some examples, the symbol may comprise a thumbnail, or a part of a picture or movie associated with the symbol.

In the same way, audio and video files can be triggered when selecting a symbol or a workspace. This adds more visual and audio context to the information a user is interacting with.

Shapes combined with symbols or multimedia content, used alone or simultaneously, may provide additional overall information, meaning, and context compared with a simple filename.

In some examples, instead of having separate, individual files for each version of a document, all versions can be stored together inside one encrypted file, which may be represented by a single symbol. This approach may: reduce visual clutter (a user does not see multiple file icons for different versions on the screen, keeping the workspace cleaner); centralize data (whether the data is stored locally, remotely, or in a version-controlled system, the symbol always points to the latest version); and streamlines file management (by consolidating changes into one container, one avoids the confusion of having many similar file versions).

Content (including data) may be abstracted away from a single file or location. A symbol can contain multiple versions of a file and can even change its location. For example, if a file to be accessed in a data center, and the data center goes offline, a symbol may automatically show a last saved version of the file, or switch to a mirror or backup location of the most recent data. The data, or content, of (e.g. associated with) a symbol can therefore be dynamic and not fixed, increasing the availability of systems or references to data which has become unavailable.

As described herein, the present invention may enable visually representing the importance of information. For example, the interface may dynamically adjust the size and prominence of desktop elements based on the user's current usage, tasks or priorities.

As a user approaches a task, symbols that are related can seamlessly grow in size, while irrelevant ones may retreat into smaller symbols. This would intuitively signal which elements are important without needing complex menu structures or searches.

In some examples, the desktop environment keeps a record of how frequently a user, or users, access(es) each symbol. As described herein, dynamic sizing may take please (i.e. the more often a symbol is used, the larger it appears, while less frequently used symbols remain smaller). This size difference can act as a visual cue. A larger symbol indicates that the information it represents is important or used frequently, making it easier for users to quickly spot key items. By adjusting icon sizes based on usage, extra visual information is provided that helps users to identify not only what the content is but also how significant it is. Overall, this approach reduces clutter and allows for a more intuitive way to manage and prioritize data visually.

In some examples, a workspace can be an interactive multimedia experience. Mousing over (e.g. hovering a pointer over) a symbol can trigger events that enhance the information about the item. The desktop can dynamically update itself programmatically, for example it can show items based on time of day or other external parameters gained locally or externally. As an example, a symbol could display a desktop of symbols of companies in which the user is investing, and related information can be dynamically shown in real-time.

In some examples, the visibility of at least some symbols may be determined by time. For example, a user may specify that only symbols representing content that was accessed within a particular time period be displayed. In some examples, a symbol may only be visible at certain times or during certain time periods (e.g. at certain times of the day, week, month, or year). In some examples, symbols may represent content that is time critical, and may only be displayed when user interaction with the content is required or possible.

In some examples, files/data/content is/are managed by the desktop environment itself and not buried in a file folder hierarchy.

As described herein, the present disclosure may provide a dynamic desktop e.g. using adaptive rendering techniques. The interface may be completely dynamic and infinite, and may make finding and organizing information significantly faster and more streamlined.

In some examples, an additional function or menu associated with a symbol may be accessed, e.g. via a right-click using a mouse. Custom tasks may be assigned to the additional function for a given symbol. For example, instead of having two separate icons for making text larger or smaller, a symbol may be assigned a left-click for one task and right-click for the other. This approach simplifies the interface, reduces information overload, and speeds up user interaction. By redefining the second mouse button, the mouse is transformed into a tool for minimizing the number of options to choose from, making the second mouse button more valuable in a desktop environment.

A scalable, draggable, pannable, and/or zoomable user interface increases available workspace seamlessly, without using traditional desktop swapping. Zooming into symbols enables individuals with visual impairments to access information more easily. High-resolution images ensure that enlarging a symbol reveals more detailed text and visuals. Since symbols can be resized without limits, they can be recognized at any scale. Moreover, with high-definition icons, these symbols convey even richer information.

In some examples, the virtual space (desktop), which may be infinite as described herein, may extend to other physical computers seamlessly, and processes that are run could use the resources on the other computers. For example, one desktop view may utilize the power of multiple computers, and by moving a symbol from one area to another could move its resources and CPU usage to a physically separate machine. Therefore, distributed processing may be achieved that is spatially controlled and driven from one user interface.

The desktop environment described herein may possess a native file system. Native files may have inbuilt encryption to protect the information from external operating system spying. For example, files or content may be dragged and dropped into a virtual space, and automatically added to a secure repository. The repository may have a dynamic and/or relational file storage structure, and the content may be automatically assigned a unique content identifier to enable access and/or retrieval of the content. In some examples, access to the repository may be dependent on a unique user identifier (such as an email address) associated with any user(s) granted permissions to access the repository. For example, users may collaborate on a project represented by symbols in a shared virtual space accessible by only those users having the necessary permissions. In some examples, the shared virtual space may be accessible by a symbol on a user's personal desktop (virtual space). Selecting that symbol may prompt the user to enter their unique user identifier (e.g. email address), and/or a password. It will be understood that “launching content” according to the present disclosure may therefore, in some examples, comprise opening the shared virtual space.

FIG. 4 illustrates a further example of a displayed portion 40 of a virtual space according to the present disclosure. The displayed portion 40 illustrated in FIG. 4 provides a schematic illustration of further features of the virtual space that may be included in some implementations.

In some examples, symbols 21s-v may be grouped together according to projects or workflows. As shown in FIG. 4, a workflow 46 may comprise a group of symbols 21s-v arranged in a process ordered task. The symbols 21s-v may be visually and/or functionally linked to each other. The workflow 46 may include text (represented by the letters “ABC” in FIG. 4), e.g. a title, to identify the workflow 46. The workflow 46 may therefore comprise a group of intelligent symbols 21s-v that guide a user through a predefined workflow to streamline how a task is executed and managed. The tasks may be seamlessly integrated, and information related, by information association.

In some examples, the virtual space may enable perimeter/location sensitive context features.

In some examples, a user may tap a side of the screen (e.g. a touchscreen), and/or gesture or click with a mouse, to cause a floating group 46 of symbols 21p-r to be displayed without the need to select or mouse click information, as shown in FIG. 4.

In another example, the mouse may be moved, and/or the screen tapped near another side or part of the screen to bring up a position-aware feature.

For example, context menus and/or symbol groups can be triggered by any event, such as a mouse hovering over a symbol in a workspace. Audio and/or visual prompts may be triggered when moving around the workspace to impart more information and meaning related to the symbol information and location. An example of a menu or other feature that may be triggered as described herein in is a displayed search bar 48, as illustrated in FIG. 4.

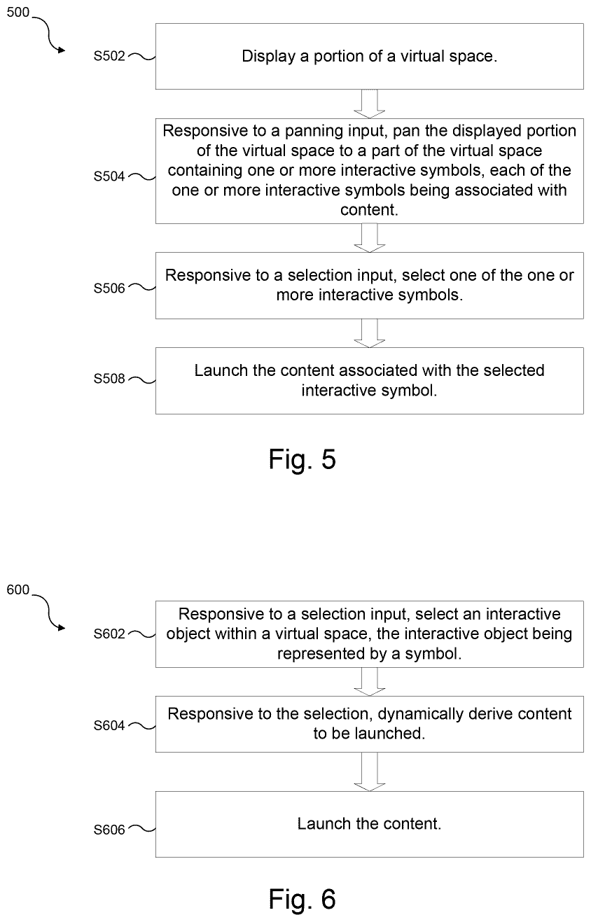

FIGS. 5 and 6 illustrate examples of methods 500, 600 (e.g. computer implemented methods) according to the present disclosure. The methods 500, 600 may be carried out, in some examples by the CPU 202 of the system 102 as shown in FIG. 1. While we refer to steps of the methods 500, 600 being performed by a single processing unit (e.g. CPU 202), the methods 500, 600 may be performed by multiple processing units (e.g. of multiple systems of computing devices). Furthermore, the methods 500, 600 may be performed by distributed processing units that may be distributed across two or more devices. Each processing unit of the distributed processing units may comprise one or more CPUs 202 referred to herein.

FIG. 5 illustrates an example of a method 500 for launching (or dynamically deriving, fetching, locating, and/or retrieving) content according to the present disclosure.

At S502, the method 500 comprises displaying a portion of a virtual space. For example, the portion of the virtual space may be displayed on the display 204 illustrated in FIG. 1.

At S504, the method 500 comprises, responsive to a panning input, panning the displayed portion of the virtual space to a part of the virtual space containing one or more interactive symbols, each of the one or more interactive symbols being associated with content. For example, the panning input may be provided by one or more of the input devices (e.g. keypad 206, mouse 208, motion control device 212, and/or touch screen 204) as illustrated in FIG. 1.

At S506, the method 500 comprises, responsive to a selection input, selecting one of the one or more interactive symbols. For example, the selection input may be provided by one or more of the input devices (e.g. keypad 206, mouse 208, motion control device 212, and/or touch screen 204) as illustrated in FIG. 1.

At S508, the method 500 comprises launching the content associated with the selected interactive symbol. For example, the content may be memory 226 (e.g. locally in a non-transitory computer readable storage medium), and/or remotely (e.g. in the cloud) and accessed via the internet e.g. via the network interface 224 as illustrated in FIG. 1.

FIG. 6 illustrates a method 600 for launching (or dynamically deriving, fetching, locating, and/or retrieving) content according to the present disclosure.

At S602, the method 600 comprises, responsive to a selection input, selecting an interactive object within a virtual space. The interactive object may be represented by a symbol. For example, the selection input may be provided by one or more of the input devices (e.g. keypad 206, mouse 208, motion control device 212, and/or touch screen 204) as illustrated in FIG. 1.

At S604, the method 600 comprises, responsive to the selection, dynamically deriving content to be launched. For example, the content may be dynamically derived according to context (e.g. inputs by the user, historic interactions with the object or the symbol, the locality of the object or the symbol, interactions with other objects or symbols in the virtual space or elsewhere, etc.).

At S606, the method 600 comprises launching the content.

Further examples, numbered E1 to E38, according to the present disclosure will now be described.
E1. A computer implemented method comprising:
displaying a portion of a virtual space;
responsive to a panning input, panning the displayed portion of the virtual space to a part of the virtual space containing one or more interactive symbols, each of the one or more interactive symbols being associated with content;
responsive to a selection input:
selecting one of the one or more interactive symbols; and
launching the content associated with the selected interactive symbol.
E2. A computer implemented method comprising:
displaying a portion of a virtual space;
responsive to a panning input, panning the displayed portion of the virtual space to a part of the virtual space containing one or more interactive symbols, each of the one or more interactive symbols being associated with content;
responsive to a selection input:
selecting one of the one or more interactive symbols; and
locating the content associated with the selected interactive symbol.
E3. A computer implemented method comprising:
displaying a portion of a virtual space;
responsive to a panning input, panning the displayed portion of the virtual space to a part of the virtual space containing one or more interactive symbols, each of the one or more interactive symbols being associated with content;
responsive to a selection input:
selecting one of the one or more interactive symbols; and
retrieving the content associated with the selected interactive symbol.
E4. A computer implemented method for launching content, the computer implemented method comprising:
responsive to a selection input, selecting an interactive object within a virtual space, the interactive object being represented by a symbol;
responsive to the selection, dynamically deriving content to be launched; and
launching the content.
E5. A computer implemented method comprising:
responsive to a selection input, selecting an interactive object within a virtual space, the interactive object being represented by a symbol; and
responsive to the selection, dynamically deriving an action to be performed.
E6. A computer implemented method comprising:
responsive to a selection input, selecting an interactive object within a virtual space, the interactive object being associated with content;
responsive to the selection, launching the content.
E7. A computer implemented method comprising:
responsive to a selection input, selecting an interactive object within a virtual space, the interactive object being associated with content;
responsive to the selection, locating the content.
E8. A computer implemented method comprising:
responsive to a selection input, selecting an interactive object within a virtual space, the interactive object being associated with content;
responsive to the selection, retrieving the content.
E9. The computer implemented method according to any one of examples E1 to E8 comprising, responsive to a zooming input, increasing or decreasing an amount of the virtual space displayed in the displayed portion of the virtual space.
E10. The computer implemented method of example E9, wherein decreasing an amount of the virtual space displayed in the displayed portion comprises increasing an amount of detail of one or more symbols displayed in the displayed portion.
E11. The computer implemented method of any one of examples E1 to E10 comprising, in response to a zooming input, changing the number of symbols displayed in the displayed portion of the virtual space.
E12. The computer implemented method according to any one of examples E1 to E11, wherein a visual property of one or more of the one or more symbols is at least partially determined by the content associated with the symbol.
E13. The computer implemented method according to any one of clauses E1 to E12 comprising, responsive to a non-selection interaction with a symbol of the one or more symbols, automatically performing an identifying action associated with the symbol.
E14. The computer implemented method according to example E13, wherein the identifying action comprises one or more of:
animating the symbol; and
playing media.
E15. The computer implemented method according to example E13 or E14, wherein the non-selection interaction comprises hovering a pointer over the symbol.
E16. The computer implemented method according to any one of examples E13 to E15, wherein the non-selection interaction comprises gesturing with a pointer over, and/or in the vicinity of, the symbol.
E17. The computer implemented method according to any one of examples E1 to E16, comprising changing a relative size of at least one symbol of the one or more symbols according to a relative number of times that the content associated with the at least one symbol is launched or accessed.
E18. The computer implemented method according to any one of examples E1 to E16, comprising displaying at least some of the symbols in a toolbar.
E19. The computer implemented method according to example E18, wherein the toolbar is an infinitely scrollable toolbar.
E20. The computer implemented method according to any one of examples E1 to E19, wherein the content is stored in a repository, the repository having a dynamic or relational storage structure, and wherein the content is assigned a unique content identifier within the repository.
E21. The computer implemented method according to example E20, wherein the repository is accessible using a cryptographically secure key.
E22. The computer implemented method according to any one of clauses E1 to E21, comprising dynamically deriving the content to be launched by selection of the symbol or object.
E23. The computer implemented method according to example E22, comprising dynamically deriving the content based a locality of the symbol or object within the virtual space.
E24. The computer implemented method according to any one of examples E1 to E23, wherein the content comprises executable computer program code.
E25. The computer implemented according to any one of examples E1 to E24, wherein the virtual space is infinite in all dimensions.
E26. A non-transitory computer readable medium comprising instructions which, when executed by a processor of a computing device, cause the computing device to carry out the computer implemented method according to any one of examples E1 to E25.
E27. A system comprising:
a display device;
an input device;
a processor;
wherein the processor is configured to:
cause the display device to display a portion of a virtual space;
responsive to a panning input from the input device, cause the portion of the virtual space displayed on the display device to pan to a part of the virtual space containing one or more interactive symbols, each of the one or more interactive symbols being associated with content; and
wherein the processor is configured, responsive to a selection input from the input device, to:
select one or more of the interactive symbols; and
launch the content associated with the selected interactive symbol.
E28. The system according to example E27, wherein the processor is configured to dynamically derive the content to be launched by selection of the interactive symbol.
E29. The system according to example E27 or E28, wherein the processor is configured to dynamically derive the content based on a locality of the interactive symbol within the virtual space.
E30. An interactive symbol within a virtual space, the interactive symbol being configured, upon selection of the interactive symbol, to dynamically derive an action to be performed by a computer.
E31. The interactive symbol according to example E30, configured to dynamically derive the action based on a locality of the interactive symbol within the virtual space.
E32. The interactive symbol according to example E30 or E31 configured, in response to a non-selection interaction, to automatically perform an identifying action.
E33. The interactive symbol according to example E32, configured to dynamically derive the identifying action.
E34. The interactive symbol according to example E32, wherein the identifying action is programmatically defined.
E35. A desktop computer environment comprising one or more interactive symbols according to any one of examples E30 to E34.
E36. A system comprising:
a processor; and
a non-transitory computer readable medium, the non-transitory computer readable medium having a repository stored thereon, the repository having a dynamic and/or relational file storage structure;
wherein the processor is configured to:
receive content to be stored in the repository;
assign, to the content, a unique content identifier to enable location and/or retrieval of the content; and
transfer the content, with the assigned unique content identifier, to the repository.
E37. A system according to example E36, wherein the repository is encrypted according to an encryption scheme.
E38. A system according to example E37, wherein the encryption scheme comprises:
combining a first unique user identifier associated with a first user and a second unique user identifier associated with a second user to create a cryptographically secure key; and
encrypting the repository using the cryptographically secure key.

In some examples, a non-transitory computer readable medium is provided, the non-transitory computer readable medium comprising instructions which, when executed by a processor of a computing device, cause the computing device to carry out any of the methods or computer implemented methods described herein.

The instructions may be provided on one or more carriers. For example there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

Generally, any of the functions described herein can be implemented using software, firmware, hardware (e.g., fixed logic circuitry), or a combination of these implementations. The terms “symbol”, “object”, “virtual space”, “desktop environment”, “workspace”, “system”, and “input”, as used herein generally represent software, firmware, hardware, or a combination thereof. In the case of a software implementation, the symbol, object, virtual space, desktop environment, workspace, system, or input at least partly represents program code that performs specified tasks when executed on a processor (e.g. CPU or CPUs). The program code can be stored in one or more computer readable memory devices. The features of the techniques described herein are platform-independent, meaning that the techniques may be implemented on a variety of commercial computing platforms having a variety of processors.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

1. A computer implemented method comprising:
displaying a portion of a virtual space;
responsive to a panning input, panning the displayed portion of the virtual space to a part of the virtual space containing one or more interactive symbols, each of the one or more interactive symbols being associated with content;
responsive to a selection input:
selecting one of the one or more interactive symbols; and
launching the content associated with the selected interactive symbol.

2. The computer implemented method according to claim 1 comprising, responsive to a zooming input, increasing or decreasing an amount of the virtual space displayed in the displayed portion of the virtual space.

3. The computer implemented method according to claim 2, wherein decreasing an amount of the virtual space displayed in the displayed portion comprises increasing an amount of detail of one or more interactive symbols displayed in the displayed portion.

4. The computer implemented method according to claim 1, comprising dynamically deriving the content to be launched by selection of the interactive symbol.

5. The computer implemented method according to claim 4, comprising dynamically deriving the content based a locality of the interactive symbol within the virtual space.

6. The computer implemented method according to claim 1, wherein a visual property of one or more of the one or more interactive symbols is at least partially determined by the content associated with the interactive symbol.

7. The computer implemented method according to claim 1 comprising, responsive to a non-selection interaction with a symbol of the one or more symbols, automatically performing an identifying action associated with the symbol.

8. The computer implemented method according to claim 7, wherein the identifying action comprises one or more of:
animating the symbol; and
playing media.

9. The computer implemented method according to claim 7, wherein the non-selection interaction comprises hovering a pointer over the symbol.

10. The computer implemented method according to claim 1, comprising changing a relative size of at least one symbol of the one or more symbols according to a relative number of times that the content associated with the at least one symbol is accessed.

11. The computer implemented method according to claim 1, comprising displaying at least some of the symbols in an infinitely scrollable toolbar.

12. The computer implemented method according to claim 1, wherein the content is stored in a repository, the repository having a dynamic or relational storage structure, and wherein the content is assigned a unique content identifier within the repository.

13. The computer implemented method according to claim 1, wherein the content comprises executable computer program code.

14. The computer implemented method according to claim 1, wherein the virtual space is infinite in all dimensions.

15. A system comprising:
a display device;
an input device;
a processor;
wherein the processor is configured to:
cause the display device to display a portion of a virtual space;
responsive to a panning input from the input device, cause the portion of the virtual space displayed on the display device to pan to a part of the virtual space containing one or more interactive symbols, each of the one or more interactive symbols being associated with content; and
wherein the processor is configured, responsive to a selection input from the input device, to:
select one or more of the interactive symbols; and
launch the content associated with the selected interactive symbol.

16. The system according to claim 15, wherein the processor is configured to dynamically derive the content to be launched by selection of the interactive symbol.

17. The system according to claim 16, wherein the processor is configured to dynamically derive the content based on a locality of the interactive symbol within the virtual space.

18. A computer implemented method for launching content, the computer implemented method comprising:
responsive to a selection input, selecting an interactive object within a virtual space, the interactive object being represented by a symbol;
responsive to the selection, dynamically deriving content to be launched; and
launching the content.

19. The computer implemented method according to claim 18, comprising dynamically deriving the content based on a locality of the selectable interactive object within the virtual space.

20. The computer implemented method according to claim 18 comprising, responsive to a non-selection interaction with the interactive object, automatically performing an identifying action associated with the interactive object.
